(19) United States
(12) Patent Application Publication
(10) Pub. No.: US 2013/0059115 A1
(43) Pub. Date: Mar. 7, 2013

(54) PAD WITH FOAM AND FABRIC

(71) Applicant: Meng Chieh Lin, Taichung City (TW)

(72) Inventor: Meng Chieh Lin, Taichung City (TW)

(21) Appl. No.: 13/225,521

(22) Filed: Sep. 5, 2011

(51) Int. Cl. B32B 3/10

(52) U.S. Cl. 428/138

(57) ABSTRACT

A pad includes a fabric, a first foam layer and a second foam layer. The second foam layer is located beneath the fabric and has multiple holes defined through the top and the bottom thereof. The second foam layer has a recessed area defined in the top thereof and a path is in communication with the recessed area and the underside of the second foam layer. The fabric is engaged with the recessed area and a periphery of the fabric extends through the path and is located at the underside of the second foam layer. The underside of the fabric that is located at the underside of the second foam layer and the underside of the second foam layer located corresponding to the recessed area are securely connected to a top of the first foam layer.

### FIELD OF THE INVENTION

The present invention relates to a pad, and more particularly, to a pad that is more durable and does not have permanent deformation.

### BACKGROUND OF THE INVENTION

A conventional pad is shown in FIG. 1 and generally includes two layers which are the top layer 100 and the bottom layer 200. The top layer 100 is a piece of fabric and the bottom layer 200 is made by foam material so that the pad is soft and flexible. However, the conventional pad tends to have permanent deformation at the position where the users apply a load often as shown in FIGS. 2 and 3. Generally, the permanent deformation is in the form of a recessed area. Besides, the conventional pad may be slippery when using it on a surface where the friction is small. Furthermore, the top layer 100 and the bottom layer 200 are glued to each other by simply overlapping the top layer 100 on the bottom layer 200, when the top layer 100 is operated by lateral forces, the top layer 100 tends to be peeled off from the bottom layer 200.

The present invention intends to provide a pad which is made by fabric and foam material, the periphery of the fabric is sandwiched between the two foam layers so that the shortcomings of the conventional pad are removed.

### SUMMARY OF THE INVENTION

The present invention relates to a pad and comprises a fabric, a first foam layer and a second foam layer, wherein the first foam layer is located beneath the fabric and has multiple holes defined through the top and the bottom thereof The second foam layer has an engaging area defined therein. The engaging area has a recessed area defined in the top of the second foam layer and a path is in communication with the recessed area and the underside of the second foam layer. The fabric is engaged with the recessed area in the top of the second foam layer and the periphery of the fabric extends through the path and is located at the underside of the second foam layer. The underside of the fabric that is located at the underside of the second foam layer and the underside of the second foam layer located corresponding to the recessed area are securely connected to the top of the first foam layer.

Preferably, the first foam layer has multiple passages defined therethrough and the passages are perpendicular to axes of the holes.

The primary object of the present invention is to provide a pad wherein the fabric and the foam layers are not separated.

Another object of the present invention is to provide a pad wherein the pad does not have permanent deformation.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional pad;

FIG. 2 shows that forces are applied to the top of the conventional pad;

FIG. 3 shows that a permanent deformation is formed in the conventional pad;

FIG. 4 is an exploded view to show the pad of the present invention, and

FIG. 5 is a cross sectional view of the pad of the present invention.

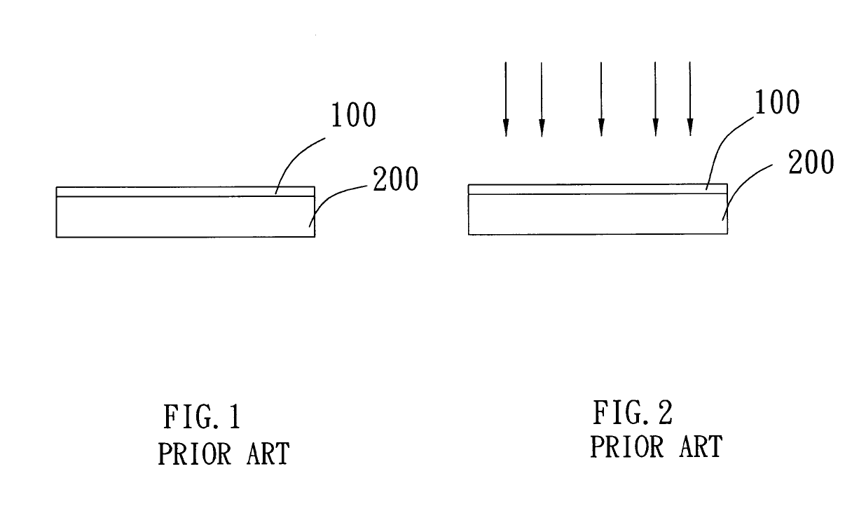

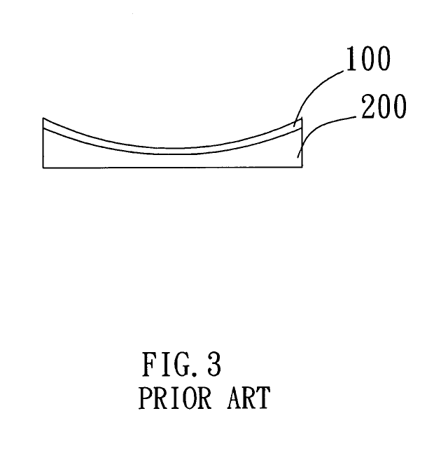

### DETAILED DESCRIPTION OF THE PREFERRED EMBODIMENT

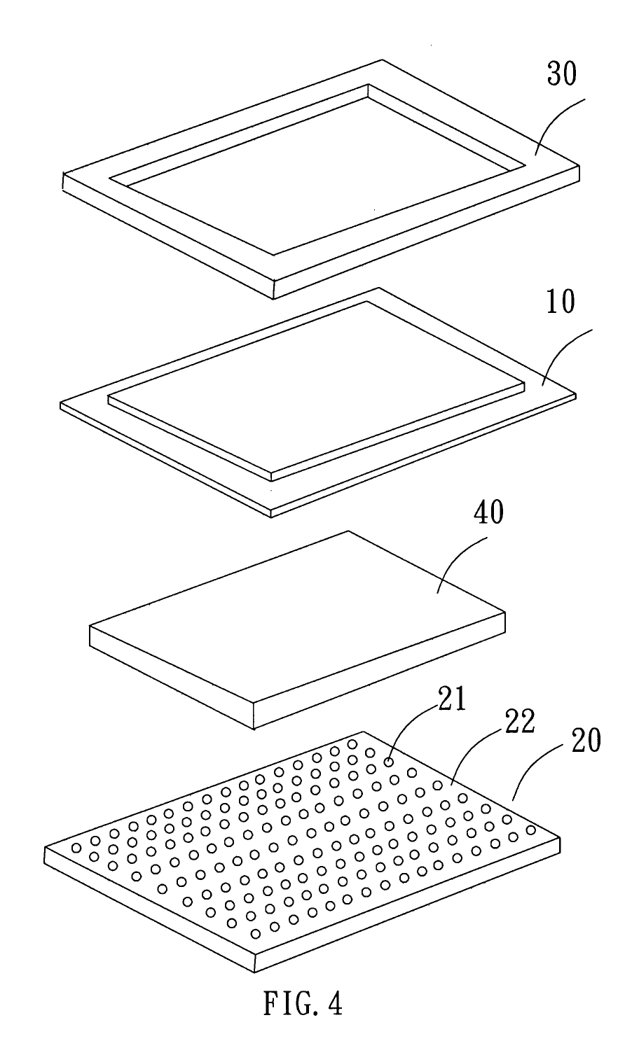

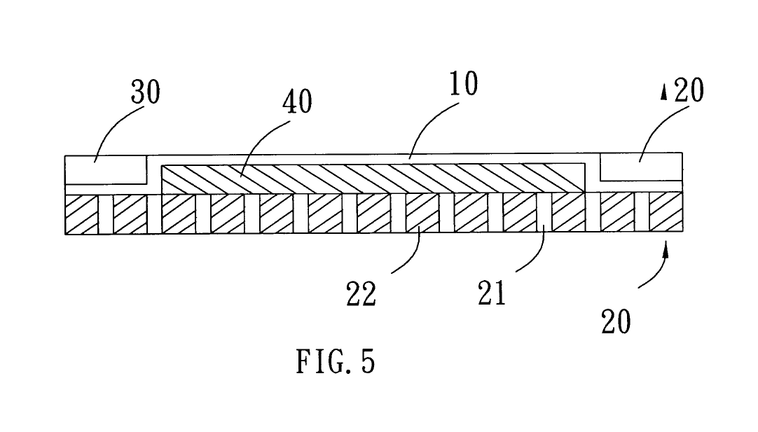

Referring to FIGS. 4 and 5, the pad of the present invention comprises a fabric 10, a first foam layer 20 and a second foam layer 30. The first foam layer 20 is located beneath the fabric 10 and has multiple holes 21 defined through the top and the bottom thereof. The first foam layer 20 further has multiple passages 22 defined therethrough and the passages 22 are perpendicular to the axes of the holes 21.

The second foam layer 30 has an engaging area defined therein, preferably, the engaging area has a recessed area defined in the top of the second foam layer 30. A path is in communication with the recessed area and the underside of the second foam layer 30. The fabric 10 is engaged with the recessed area in the top of the second foam layer 30 and the periphery of the fabric 10 extends through the path and is located at the underside of the second foam layer 30. The underside of the fabric 10 that is located at the underside of the second foam layer 30 and the underside of the second foam layer 30 located corresponding to the recessed area are securely connected to the top of the first foam layer 20.

The periphery of the fabric 10 is sandwiched between the underside of the second foam layer 30 and the first foam layer 20 so that the fabric 10 is securely positioned and does not peel off from the first and second foam layers 20, 30. The first foam layer 20 is located at the bottom of the pad so that the pad does not slip when used on a surface with less friction. The first foam layer 20 also keeps the pad to be flat. Besides, the first foam layer 20 have holes 21 and passages 22, because the surface tension on each small area is larger than the extension force so that the pad is more durable and does not deform permanently.

While we have shown and described the embodiment in accordance with the present invention, it should be clear to those skilled in the art that further embodiments may be made without departing from the scope of the present invention.

What is claimed is:

1. A pad comprising:
a fabric;
a first foam layer located beneath the fabric and having multiple holes defined through a top and a bottom thereof, and
a second foam layer having an engaging area defined in a top thereof, a path being in communication with the engaging area and an underside of the second foam layer, the fabric engaged with the engaging area in the top of the second foam layer and a periphery of the fabric extending through the path and located at the underside of the second foam layer, an underside of the fabric that is located at the underside of the second foam layer and the underside of the second foam layer located corresponding to the engaging area being securely connected to a top of the first foam layer.

2. The pad as claimed in claim 1, wherein the engaging area has a recessed area defined in the top of the second foam layer and the path is in communication with the recessed area and the underside of the second foam layer.

3. The pad as claimed in claim 1, wherein the first foam layer has multiple passages defined therethrough and the passages are perpendicular to axes of the holes.
